(19) United States
(12) Patent Application Publication
(10) Pub. No.: US 2019/0142552 A1
(43) Pub. Date: May 16, 2019

(54) GINGIVAL CONE COLLARS FOR DENTAL IMPLANTS

(71) Applicants: Jiachang ZHANG, Anaheim, CA (US); Huimin ZHAO, Anaheim, CA (US)

(72) Inventors: Jiachang ZHANG, Anaheim, CA (US); Huimin ZHAO, Anaheim, CA (US)

(21) Appl. No.: 16/188,214

(22) Filed: Dec. 4, 2018

Related U.S. Application Data
(60) Provisional application No. 62/584,782, filed on Nov. 11, 2017.

(51) Int. Cl. A61C 8/00

(52) U.S. Cl. CPC A61C 8/008; A61C 8/0001; A61C 8/0077; A61C 8/0069

(57) ABSTRACT

A gingival cone collar for dental implants includes a top section, the top section having a truncated zone shape and including a top open end and a bottom open end, the top open end being larger than the bottom open end; a connection section, the connection section having a ring shape; and a bottom section, the bottom section having a top open end and a bottom open end. The connection section connects the bottom open end of the top section with the top open end of the bottom section.

The present invention claims priority to U.S. Provisional Application No. 62/584,782, filed on Nov. 11, 2017, which is incorporated by reference for all purposes as if fully set forth herein.

### FIELD OF THE INVENTION

The present invention relates to gingival cone collars for dental implants.

### BACKGROUND OF THE INVENTION

Dental implant is a missing tooth restoration method. An implant (artificial tooth root) is implanted into the alveolar bone of the jawbone of a patient. After the implant is fused with alveolar bone, a crown or restoration is made on the implant. Dental implant has become one of the preferred dental repair methods.

In general, a dental implant has four parts: implant, abutment, screw connecting the implant and abutment, and crown. The implant anchors the dental implant to the jawbone. The abutment is located at the top of the implant. The screw connects the abutment and the implant. The crown replicates the contour and appearance of the visible portion of the missing tooth.

Standard methods for preparing dental implants require considerable time, labor, and expense. Methods usually require multiple visits to the dentist's office to complete installation of the dental implant. For example, during a first office visit, a dental implant is installed in the patient's jawbone. At a second visit, a temporary healing abutment is installed onto the implant. After healing, at a third visit, an impression of the patient's mouth showing the position of the implant fixture relative to the natural dentition is made. From this impression, a customized abutment is prepared. Because of multiple steps involved in this process, errors often occurs and have an impact on accuracy of the restoration. At a fourth visit, the abutment is installed along with a temporary crown. At a fifth visit, the crown is installed. The number of visits required increases if the abutment or crown needs to be modified before installation of the final crown.

The standard procedure therefore requires a considerable number of visits to the dentist's office for the patient and the labor of dental professionals. The time and labor add to the high cost of dental implant. Accordingly, there remains a need for a method that will reduces the time, labor and cost of dental implant installation. The present invention addresses this need by providing a gingival cone collar that can be used in dental implant and abutment installation to reduce the time, labor and cost of dental implant installation. In addition, the gingival cone collar prevents bleeding from entering inside of the gingival cone collar and contacting the abutment. Thus, oral scan of the implant site can be conducted accurately, and impression of the implant site can also be done with high precision. The gingival cone collar can help the gums heal naturally and form emergence profile.

### SUMMARY OF THE INVENTION

In one embodiment, the present invention provides a gingival cone collar for dental implants. The gingival cone collar includes a top section, the top section having a truncated zone shape and including a top open end and a bottom open end, the top open end being larger than the bottom open end; a connection section, the connection section having a ring shape; and a bottom section, the bottom section having a top open end and a bottom open end. the connection section connects the bottom open end of the top section with the top open end of the bottom section.

In another embodiment, the connection section has a horizontal flat ring shape or a substantially horizontal flat ring shape.

In another embodiment, the bottom section has a column shape or a truncated zone shape.

In another embodiment, the top open end of the top section has a radius of 3-7 mm, preferably, 4-6 mm.

In another embodiment, the top section has a slant height of 3-5 mm.

In another embodiment, the top section has a slant angle of 20-60°, 30-50°, or 35-45°.

In another embodiment, the connection section has a width of 0.5-1.5 mm.

In another embodiment, the bottom section has a slant height of 0.5-3.5 mm, preferably, 0.5-1.5 mm.

In another embodiment, a radius of the bottom open end of the top section is 0.5-3 mm larger than the top open end of the bottom section, preferably, 0.5-1.5 mm larger than the top open end of the bottom section.

In another embodiment, the gingival cone collar is made of a plastic material, a metal, or a bio-compatible material.

In another embodiment, the top open end of the top section has a squircle, oval, or rounded triangle shape.

In another embodiment, the gingival cone collar is adopted for fitting an abutment or a scan body.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows that a gingival cone collar used with an implant and an abutment in dental implant.

FIG. 2 shows the top view of the gingival cone collar of FIG. 1, and the top end of the top section of the gingival cone collar has a squircle (square cycle) (A), oval (B), or rounded triangle (C) shape.

FIG. 3 shows a gingival cone collar having a top section, a connection section, and a bottom section.

FIG. 4 shows a gingival cone collar having a top section, a connection section, and a bottom section that includes 2 subsections.

### DETAILED DESCRIPTION OF THE ILLUSTRATED EMBODIMENTS

Reference will now be made in detail to embodiments of the present invention, example of which is illustrated in the accompanying drawings.

The present invention provides a gingival cone collar that can be used in dental implant and abutment installation to reduce the time, labor and cost of dental implant installation.

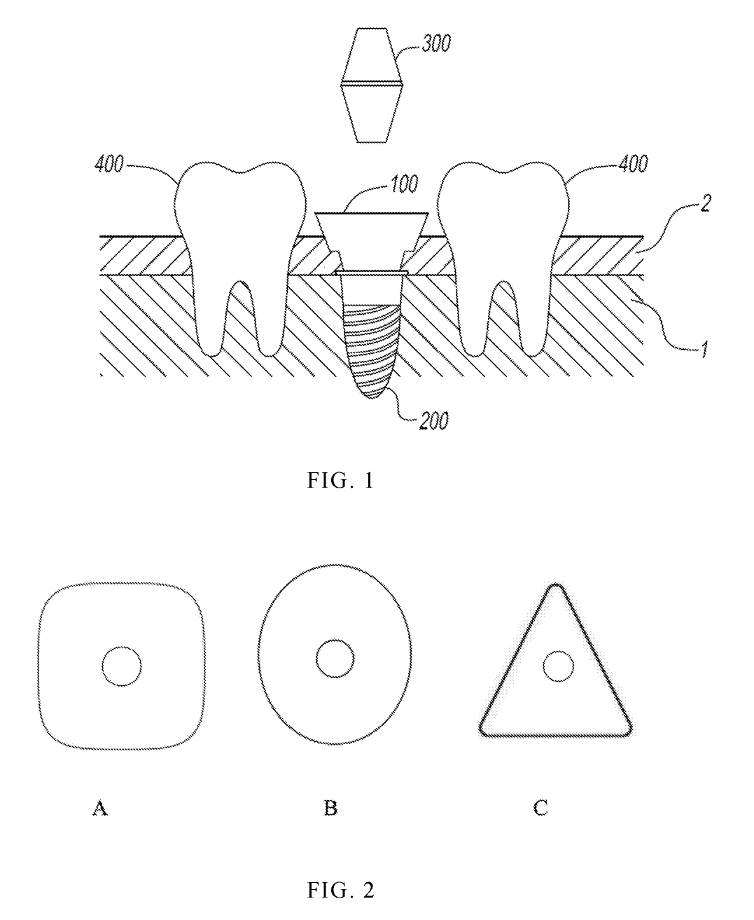

As shown in FIG. 1, when a dental implant procedure begins, gums (2) at an implant site that is between two teeth (400) are cut open, and an implant (200) is inserted into the jaw bone (1) of a patient.

A gingival cone collar (100) can be placed onto the inserted implant (200). The gingival cone collar (100) is placed on a top opening of the implant. When an abutment (300) connects with the implant, the gingival cone collar (100) is located below the widest point of the abutment (300) and fits tightly with outer surface of the abutment (300). The abutment (300) can be a stock abutment or a customer abutment. Stock abutments are manufactured to standard sizes and can be used on implants. Custom abutments are designed and manufactured based on the patients' gingival architectures.

The abutment (300) can also be a scan body. A scan body is a device that attaches to the implant before scanning, providing for the exact position of the implant in the scanned model.

The gingival cone collar (100) separates the abutment (300) from the bone (1) surface and the gums (2) and prevents bone and gum bleeding from entering inside of the gingival cone collar. Furthermore, the gingival cone collar (100) creates a natural gum emergence profile at the implant site. The gum emergence profile is the contour of the gums and the abutment.

After the abutment (300) is connected to the implant (200), dental resin can be added to the space between the abutment (300) and the gingival cone collar (100) to form a healing abutment structure. The healing abutment structure includes the gingival cone collar (100), dental resin, and the abutment (300), and the abutment (300) can also be a scan body. After insertion of the implant, a period of time is given for the tissue to heal and for the bone to grow sufficiently around the implant for the dental implant to become securely engaged in the jaw. After the healing period, the healing abutment structure is removed, and a dental prosthesis for the dental implant is installed. The number of visits to the dentist's office for the patient and the labor of dental professionals can be reduced by using the gingival cone collar (100) and the healing abutment structure.

FIG. 2 shows the top view of the gingival cone collar (100) of FIG. 1, and the top can be a squircle (square cycle) (A), oval (B), or rounded triangle (C) shape. The squircle, oval, and rounded triangle shapes are designed to create a natural gum emergence profile. Any other shapes that are close to the shapes of the natural teeth can also used here.

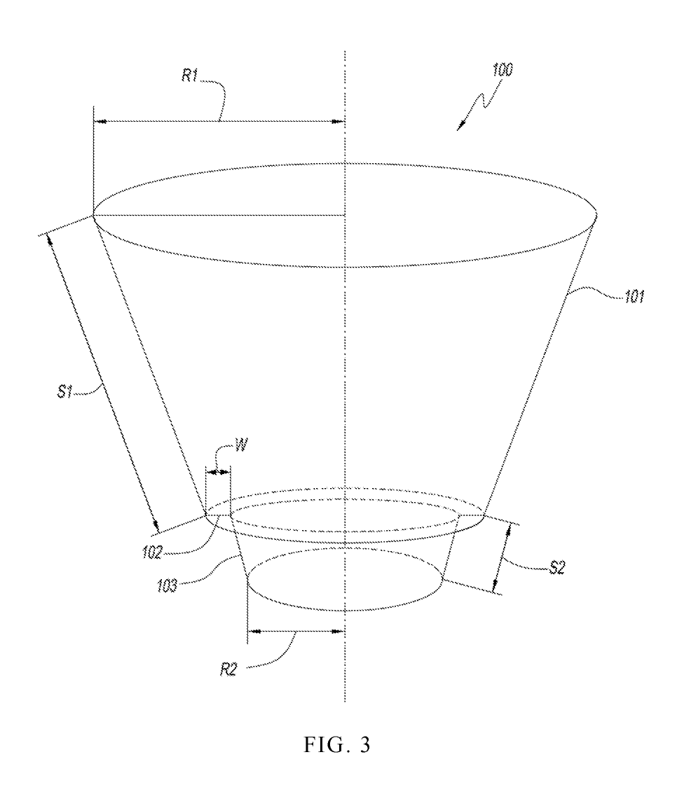

FIG. 3 shows that the gingival cone collar (100) has a top section (101), a connection section (102), and a bottom section (103). For simplicity of illustration, the top section (101) is shown to have a circular shape top. The top end of the top section (101) can have a squircle, oval, or rounded triangle shape, as shown in FIG. 2.

The top section (101) may have a truncated zone shape, and include a top open end and a bottom open end. The connection section (102) has a ring shape. Preferably, the connection section (102) has a horizontally flat ring shape. The bottom section (103) also has a top open end and a bottom open end. The bottom section (103) may have a column shape or a truncated zone shape. The connection section (102) connects the bottom open end of the top section (101) with the top open end of the bottom section (103).

The top open end of the top section (101) may be circular open end that has a radius (R1) of 3-6 mm. The top section has a slant height (S1) of 3-5 mm. The top section (101) has a slant angle of 20-60°, 30-50°, or 35-45°. The slant angle is the acute angle formed the slant height line of top section (101) and a vertical line in FIG. 3.

The connection section (102) has a width (W) of 0.5-1 mm. The bottom section (103) has a height (S2) of 0.5-1.5 mm. Preferably, a radius of the bottom open end of the top section is 0.5-1 mm larger than a radius (R2) of the bottom section (103). When the bottom section (103) has a column shape, the radius (R2) is the radius of the column. When the bottom section (103) has a truncated zone shape, the radius (R2) is the radius of the bottom of circle of the truncated zone. The bottom section (103) has a slant angle of 20-60°, 30-50°, or 45-45°.

When the top of the top section (101) has a squircle, oval, or rounded triangle shape, the radius (R1) is the average distance from the center of the squircle, oval, or rounded triangle to the circumference.

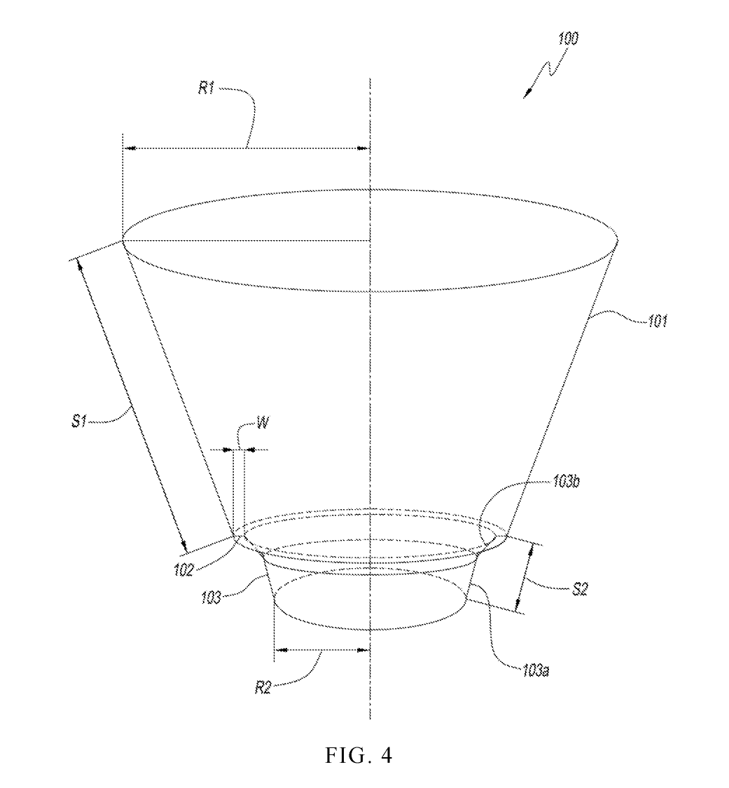

FIG. 4 shows another example of the gingival cone collar (100). In this example, the gingival cone collar (100) has a top section (101), a connection section (102), and a bottom section (103), and bottom section (103) includes a main subsection (103a) and a connection subsection (103b). For simplicity of illustration, the top section (101) is shown to have a circular shape top. The top end of the top section (101) can have a squircle, oval, or rounded triangle shape, as shown in FIG. 2.

The top section (101) may have a truncated zone shape, and include a top open end and a bottom open end. The connection section (102) has a ring shape. Preferably, the connection section (102) has a horizontally flat ring shape.

The main subsection (103a) may have a column shape or a truncated zone shape, and the connection subsection (103b) has a truncated zone shape. The connection subsection (103b) connects the connection section (102) and main subsection (103a).

The top open end of the top section (101) may be circular open end that has a radius (R1) of 3-6 mm. The top section has a slant height (S1) of 3-5 mm. The top section (101) has a slant angle of 20-60°, 30-50°, or 35-45°. The slant angle is the acute angle formed the slant height line of top section (101) and a vertical line in FIG. 4.

The connection subsection (103b) has a truncated zone shape, with a slant height of 0.5-1 mm and a slant angle of 10-50°, 20-40°, or 25-35°. Preferably, the slant angle of the connection subsection (103b) is smaller than the slant angle of the top section (101). The connection subsection (103b) creates a tight fit between the gingival cone collar (100) and abutment (or scan body) (300). The connection subsection (103b) also creates a better natural gum emergence profile.

The connection section (102) has a width (W) of 0.5-1 mm. The main subsection (103a) has a height (S2) of 0.5-1.5 mm. Preferably, a radius of the bottom open end of the top section is 0.5-1 mm larger than a radius (R2) of the main subsection (103a). When the main subsection (103a) has a column shape, the radius (R2) is the radius of the column. When the main subsection (103a) has a truncated zone shape, the radius (R2) is the radius of the bottom of circle of the truncated zone. The main subsection (103a) has a slant angle of 20-60°, 30-50°, or 45-45°.

When the top of the top section (101) has a squircle, oval, or rounded triangle shape, the radius (R1) is the average distance from the center of the squircle, oval, or rounded triangle to the circumference.

Preferably, the gingival cone collar is made of a plastic material or a metal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A gingival cone collar for dental implants comprising:
a top section, the top section having a truncated zone shape and including a top open end and a bottom open end, the top open end being larger than the bottom open end;
a connection section, the connection section having a ring shape; and
a bottom section, the bottom section having a top open end and a bottom open end,
wherein the connection section connects the bottom open end of the top section with the top open end of the bottom section.

2. The gingival cone collar of claim 1, wherein the connection section has a horizontal flat ring shape or a substantially horizontal flat ring shape.

3. The gingival cone collar of claim 1, wherein the bottom section has a column shape or a truncated zone shape.

4. The gingival cone collar of claim 1, wherein the top open end of the top section has a radius of 3-7 mm.

5. The gingival cone collar of claim 1, wherein the top section has a slant height of 3-5 mm.

6. The gingival cone collar of claim 1, wherein the top section has a slant angle of 20-60°, 30-50°, or 35-45°.

7. The gingival cone collar of claim 2, wherein the connection section has a width of 0.5-1.5 mm.

8. The gingival cone collar of claim 1, wherein the bottom section has a slant height of 0.5-1.5 mm.

9. The gingival cone collar of claim 1, wherein a radius of the bottom open end of the top section is 0.5-3 mm larger than the top open end of the bottom section.

10. The gingival cone collar of claim 1, wherein the gingival cone collar is made of a plastic material, a metal, or a bio-compatible material.

11. The gingival cone collar of claim 1, wherein the top open end of the top section has a squircle, oval, or rounded triangle shape.

12. The gingival cone collar of claim 1, wherein the gingival cone collar is adopted for fitting an abutment or a scan body.
